(19) United States
(12) Patent Application Publication
(10) Pub. No.: US 2015/0180947 A1
(43) Pub. Date: Jun. 25, 2015

(54) INFORMATION-PROVIDING DEVICE, INFORMATION-PROVIDING SYSTEM

(71) Applicant: Masato Endo, Nagoya-shi (JP)

(72) Inventor: Masato Endo, Nagoya-shi (JP)

(73) Assignee: TOYOTA JIDOSHA KABUSHIKI KAISHA, Aichi (JP)

(21) Appl. No.: 14/411,722

(22) PCT Filed: Jun. 29, 2012
(86) PCT No.: PCT/JP12/66727

§ 371 Date: Dec. 29, 2014

(51) Int. Cl. H04L 29/08; H04L 29/06

(52) U.S. Cl. CPC H04L 67/10; H04L 67/22; H04L 67/42

(57) ABSTRACT

An information-providing system for providing information to a user includes an information terminal including a display unit as an output unit capable of outputting information, and an information management server for managing a predetermined site, which is registered by the user and is capable of providing information on a network, the information management server being connected to the information terminal via networks to be able to communicate information to and from the information terminal. The information terminal and the information management servers respectively include control units for causing, when a significant change has been made, through involvement of another party other than the user, to a site status of the predetermined site, the display unit as the output unit to output recommendation information for recommending access to the predetermined site.

### TECHNICAL FIELD

The present invention relates to a technology for providing information to a user.

### BACKGROUND ART

In Patent Literature 1, there is disclosed a network system for providing road traffic information to a user. The network system has features in that an image captured by a surveillance camera installed at a fixed point near a road is saved in a server to deliver the image to the user, and a photographing time interval of the surveillance camera is changed based on a user's frequency of access to the server. In Patent Literature 2, there is disclosed a technology for notifying a user as needed whether or not there are updates to all contents that have been registered in advance.

### CITATION LIST

### Patent Literature

[PTL 1] JP 2006-254059 A

[PTL 2] JP 2004-318389 A

### SUMMARY OF INVENTION

According to the network system disclosed in Patent Literature 1, it is possible to acquire detailed information on an image which a user frequently accesses the server to retrieve. However, in order to acquire such information, the user needs to actively access the server. In particular, in the case of the image captured at the fixed point, while a change of the image is small and the number of accesses to the server is large at the beginning of release, the number of accesses to the server may drop with a passage of time or an increase of the number of registered sites. In consequence, in this network system, the user may miss important information or an update to information. In order to deal with such a situation, countermeasures such as use of the system disclosed in Patent Literature 2 may be taken. However, even when this system is used, if the number of registered contents is large, the possibility that the user may miss important information or the update to information is not eliminated, and the user may even feel burdensome due to notification of unimportant information.

The present invention has been made in view of the above-mentioned problems, and it is an object of the invention to provide a technology useful for reliably providing information necessary for a user without giving any burdensome feeling to a user.

In order to achieve the above-mentioned object, according to one embodiment of the present invention, there is provided an information-providing device for providing information to a user (user of information-providing device). The information-providing device includes an output unit and a control unit. The output unit is configured to output information. In this case, the information output from the output unit may be information displayed by a display device such as a display or a monitor, or information output in the form of a sound by an audio output device such as a speaker. The control unit has a function of causing, when a significant change has been made, through involvement of another party other than the user, to a site status of a predetermined site registered by the user and capable of providing information on a network, the output unit to output recommendation information for recommending access to the predetermined site. This enables the user to recognize the recommendation information output from the output unit. As a result, this control unit can be referred to as output means for outputting the recommendation information. As this information-providing device, typically, an information terminal (mobile phone (including smartphone)), a personal computer (PC), or a navigation device mounted on a vehicle can be used.

As the “site status of the site” as used herein, typically, various types of information (e.g., contents, images (moving image, still image), movies, music, theaters, literatures, photographs, cartoons, animations, computer games, and others such as characters, graphics, colors, sounds, or movements, or combination of those) registered (also referred to as “posted”) in the site by another party and opened to the public in the site, or an access status where another party has accessed the site (number of accesses, frequency of accesses, access hour (time zone), or times of accesses, or the like) can be given. The “significant change” as used herein can be regarded not as an error or an accident but clearly as a meaningful or substantiated change. Accordingly, it is preferred to determine whether or not a current event is a significant change by using a criterion (criterion enabling removal of error or accident) set in advance. The “another party” as used herein is those other than a predetermined user of the information-providing device. Another party widely includes those having special relationship with the predetermined user such as friends or people belonging to the same community, and those having no special relationship with the user. Another party may be the same person or a plurality of people.

The significant change that has been made to the site status through the involvement of another party other than the user is important information for the user. In this case, the user can confirm, after recognition of the recommendation information on the site registered in advance, the significant change of the site status by accessing the site when necessary. Thus, the above-mentioned information-providing device can reliably provide the information necessary for the user without giving any burdensome feeling to the user.

In the information-providing device according to one embodiment of the present invention, the site status is preferably a status of information of the site, the information of the site being registered by another party in the site and opened to public in the site. In this case, the control unit can determine that a significant change has been made, for example, when the information of the site is updated. Thus, without giving any burdensome feeling to the user, the updating of the information of the site can be reliably notified to the user.

In the information-providing device according to one embodiment of the present invention: the information of the site is preferably a fixed point image, which is an image of a preset fixed point registered in the site by another party; and the control unit preferably determines that a significant change has been made to the status of the information of the site when the fixed point image is updated. Thus, the control unit can be referred to as determination means for determining that a significant change has been made to the status of the information in the site when the fixed point image is updated. Accordingly, without giving any burdensome feeling to the user, the updating of the fixed point image, which is the information of the site, can be reliably notified to the user. In particular, concerning information such as the fixed point image where a change is small, chances for actively accessing the site for managing the information by the user are predicted to be reduced with a passage of time or an increase of the number of registered sites. Thus, the information-providing device according to one embodiment of the present invention is effective as means for preventing the user from missing necessary information.

In the information-providing device according to one embodiment of the present invention, the site status is preferably an access status (number of accesses, frequency of accesses, access hour (time zone), or times of accesses, or the like) of the site by another party. In this case, the control unit can determine that a significant change has been made, for example, when the access status of the site by another party greatly changes. For example, when the number of accesses of one or a plurality of others reaches a threshold value, when the frequency of accesses of one or a plurality of others within a fixed period reaches a threshold value, or when access hour (time zone) or times of accesses of one or a plurality of others are uneven, the control unit determines that a significant change has been made. As a result, without giving any burdensome feeling to the user, the great change of the access status of the site by another party can be reliably notified to the user.

In the information-providing device according to one embodiment of the present invention, the access status is preferably a number of accesses to the site by a person who is another party in one or a plurality of social networking services (SNSs) and belongs to the same community as a community of the user. Further, the control unit preferably determines that a significant change has been made to the access status when the number of accessing times reaches a preset threshold value. Accordingly, the control unit can be referred to as determination means for determining that a significant change has been made to the access status when the number of accesses reaches the predetermined threshold value. In this case, the number of accesses may be a total value of the number of accesses by another party, namely, an absolute number, or the number of accesses by another party per unit time, namely, a change rate. As the “same community” as used herein, typically, a community on a network where schools, regions, or hobbies are identical or similar can be given. Thus, without giving any burdensome feeling to the user, the fact that the number of accesses to the site by another party belonging to the same community as that of the user has reached the threshold value can be reliably notified to the user. Moreover, a tendency of another party having a nature and a sense of value similar to those of the user is reflected, and thus important information having particularly high relevance to the user can be accurately provided.

In the information-providing device according to one embodiment of the present invention, the control unit preferably changes, when the user accesses the site in response to the recommendation information output from the output unit, a criterion for determining that a significant change has been made to the site status, based on a browsing mode of the user in the site. Accordingly, the control unit can be referred to as changing means for changing the criterion for determining that the significant change has been made to the site status. As the “browsing mode of the user”, typically, time or an hour when the user browsed the site and the number of actions made by the user in the site (e.g., number of times of browsing web pages (number of pages), or number of clicking times on web page) can be given. In this case, when the user seems to show an insufficient interest to an information status in the site even if the user has accessed the site in response to the recommendation information (e.g., the user closes site immediately after accessing the site (within short time), setting can be changed so that a criterion becomes stricter, namely, outputting of the recommendation information becomes difficult. As a result, information to be notified to the user can be selected more carefully.

According to one embodiment of the present invention, there is provided an information-providing system for providing information to a user (user of information-providing device). The information-providing system includes an information terminal and an information management server. The information terminal includes an output unit capable of outputting information. The information management server manages a predetermined site, which is registered by the user and is capable of providing information on a network, the information management server being connected to the information terminal via the network to be able to communicate information to and from the information terminal. The information terminal or the information management server includes a control unit for causing, when a significant change has been made, through involvement of another party other than the user, to a site status of the site, the output unit to output recommendation information for recommending access to the site. In this case, the user can confirm, after recognition of the recommendation information on the site registered by the user in advance, the significant change of the site status by accessing the site when necessary. Thus, the above-mentioned information-providing system can reliably provide information necessary for the user without giving any burdensome feeling to the user.

In the information-providing system according to one embodiment of the present invention, the site status is preferably a status of information in the site, the information in the site being registered by another party in the site and opened to public in the site. In this case, the control unit can determine that a significant change has been made, for example, when the information in the site is updated. Thus, without giving any burdensome feeling to the user, the updating of the information in the site can be reliably notified to the user.

The information-providing system according to one embodiment of the present invention preferably includes a photographing device capable of capturing an image at a preset fixed point and transmitting information on the image to the information management server via the network. In the information providing system, the information in the site is preferably a fixed point image, which is the image of the preset fixed point captured by the photographing device and registered in the site by another party, and the control unit preferably determines that a significant change has been made to the status of the information in the site when the fixed point image is updated. The “image” as used herein includes a moving image (“dynamic picture image” or “video”) and a still image (or “static image”). Accordingly, without giving any burdensome feeling to the user, the updating of the fixed point image that is the information in the site can be reliably notified to the user. In particular, concerning information such as the fixed point image where a change is small, chances for actively accessing the site for managing the information by the user are predicted to be reduced with a passage of time or an increase of the number of registered sites. Thus, the information-providing system according to one embodiment of the present invention is effective as means for preventing the user from missing necessary information.

In the information-providing system according to one embodiment of the present invention, the site status is preferably an access status (number of accesses, frequency of accesses, access hour (time zone), or times of accesses) to the site made by another party. In this case, the control unit can determine that a significant change has been made, for example, when the access status of another party to the site greatly changes. As a result, without giving any burdensome feeling to the user, the great change of the access status of another party to the site can be reliably notified to the user.

In the information-providing system according to one embodiment of the present invention, the access status is preferably a number of accesses to the site by a person who is another party in one or a plurality of social networking services (SNSs) and belongs to the same community as a community of the user. The control unit preferably determines that a significant change has been made to the access status when the number of accesses reaches a preset threshold value. Accordingly, without giving any burdensome feeling to the user, the fact that the number of accesses to the site by another party belonging to the same community as that of the user has reached the threshold value can be reliably notified to the user. Moreover, a tendency of another party having a nature and a sense of value similar to those of the user is reflected, and thus important information having particularly high relevance to the user can be accurately provided.

In the information-providing system according to one embodiment of the present invention, the control unit preferably changes, when the user accesses the site in response to the recommendation information output from the output unit, a criterion for determining that a significant change has been made to the site status, based on a browsing mode of the user in the site. As a result, the information to be notified to the user can be selected more carefully.

### BRIEF DESCRIPTION OF DRAWINGS

FIG. 1 is a schematic diagram illustrating an information-providing system 10 according to the present invention.

FIG. 2 is a perspective view illustrating an appearance of a vehicle V that is an example of a predetermined object 110.

FIG. 3 is a flowchart illustrating “registration processing” by the information-providing system 10.

FIG. 4 is a diagram illustrating a state where a moving image A of a moving image distribution site is displayed on a display unit 320 of an information terminal 300.

FIG. 5 is a diagram illustrating a state where information regarding remind registration is displayed on the display unit 320 of the information terminal 300.

FIG. 6 is a diagram illustrating a state where information regarding remind registration is displayed on the display unit 320 of the information terminal 300.

FIG. 7 is a diagram illustrating a state where information regarding remind registration is displayed on the display unit 320 of the information terminal 300.

FIG. 8 is a flowchart illustrating “recommendation processing” by the information-providing system 10.

FIG. 9 is a diagram illustrating a state where information regarding recommendation in Step S205 of FIG. 8 is displayed on the display unit 320 of the information terminal 300.

FIG. 10 is a graph showing an example of timing of the recommendation in Step S205 of FIG. 8.

FIG. 11 is a graph showing an example of timing of the recommendation in Step S205 of FIG. 8.

FIG. 12 is a schematic diagram illustrating an information-providing system 20 according to the present invention.

FIG. 13 is a flowchart illustrating “recommendation processing” by the information-providing system 20.

FIG. 14 is a diagram illustrating a state where information regarding recommendation in Step S305 illustrated in FIG. 13 is displayed on a display unit 320 of an information terminal 300.

FIG. 15 is a schematic diagram illustrating an information-providing system 30 according to the present invention.

### DESCRIPTION OF EMBODIMENTS

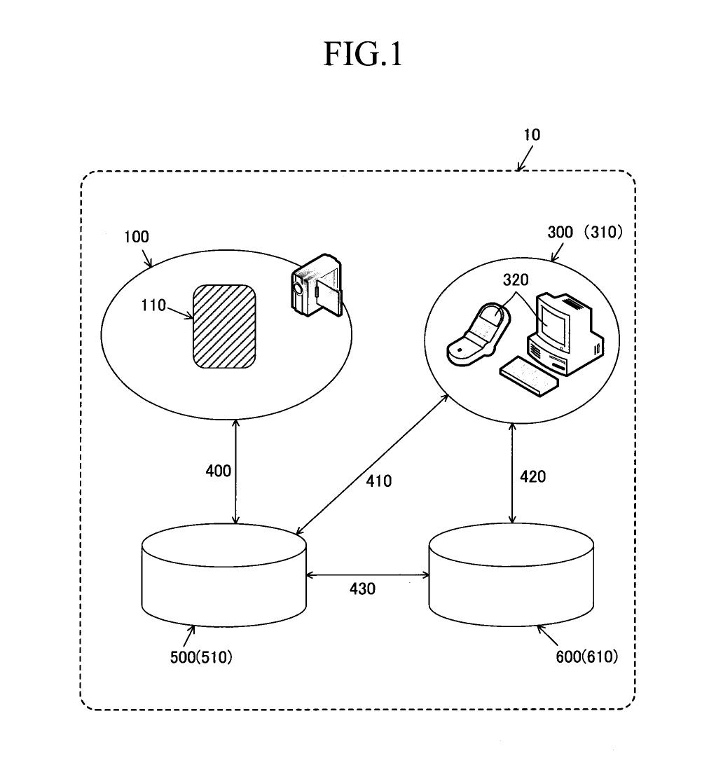

Now, an information-providing system according to an embodiment of the present invention is described referring to the drawings. FIG. 1 is a schematic diagram illustrating an information-providing system 10 according to the present invention. The information-providing system 10 corresponds to an “information-providing system” according to the present invention.

The information-providing system 10 illustrated in FIG. 1 is a system for providing information to a user (user of information-providing system 10 or information terminal 300). The information-providing system 10 includes, as components, a photographing device 100, the information terminal 300, a moving image distribution server 500, an SNS server 600, and networks 400, 410, 420, 430. FIG. 1 illustrates only one photographing device 100 and only one information terminal 300 for the sake of convenience. Typically, a plurality of photographing devices 100 and a plurality of information terminals 300 are included in the information-providing system 10. When necessary, another component can be added to the information-providing system 10. Alternatively, the information-providing system 10 can be configured only by the photographing device 100, the information terminal 300, the moving image distribution server 500, and the networks 400 and 410.

The photographing device 100 is a device for capturing a moving image of a predetermined object 110 set in advance. At least a moving image (also referred to as “dynamic picture image” or “video”) of the predetermined object (also referred to as “object”) 110 is acquired by the photographing device 100. The photographing device 100 may be configured to acquire a still image (also referred to as “static image”) in addition to the moving image of the predetermined object 110. The photographing device 100 is temporarily or continuously connected to the moving image distribution server 500 via a predetermined network (e.g., secure line network such as Internet line network or dedicated line network) 400 so as to be able to communicate information to/from the moving image distribution server 500. Accordingly, image information acquired by the photographing device 100, namely, an image including the predetermined object 110, is transmitted to the moving image distribution server 500 via the network 400.

The photographing device 100 can be controlled based on a control signal transmitted from the moving image distribution server 500 via the network 400 when necessary. For example, when the photographing device 100 is configured as a live camera for photographing a fixed point or an unfixed point, a direction, a focal distance, or the like of the live camera can be adjusted based on the control signal from the moving image distribution server 500. In the case of the photographing device 100 for photographing the fixed point, fixed point images are acquired continuously or at every fixed time interval. The photographing device 100 corresponds to a “photographing device” of the present invention.

As the predetermined object 110, for example, a vehicle, a person, a building, a signboard, a decoration, and plants and animals, and so on can be given. A typical example of the vehicle may be an automobile, a bicycle, a railway vehicle such as an electric train, or a racing vehicle to be used for racing (competition) such as Formula 1 (F1).

The information terminal 300 is used to access the moving image distribution server 500 by a user wishing distribution of the image of the predetermined object 110. For this purpose, the information terminal 300 is temporarily or continuously connected to the moving image distribution server 500 via the network 410 similar to the network 400 so as to be able to communicate information to/from the moving image distribution server 500. Moreover, the information terminal 300 is used by a user wishing registration of information with one or a plurality of social networking services (also referred to as “SNS” or “network services that can be registered or to which the user can post information”) as social network services, or a user wishing browsing of information, to access the SNS server 600 for managing the SNS. For this purpose, the information terminal 300 is temporarily or continuously connected to the SNS server 600 via the network 420 similar to the network 400 so as to be able to communicate information to/from the SNS server 600. The information terminal 300 includes a control unit 310 and a display unit 320.

The control unit 310 is a microcomputer including such main components as a CPU, a ROM, and a RAM, and can execute a program stored in the control unit 310 itself or a program on a network as occasion demands. The display unit 320 is configured as a display device (display or monitor) capable of displaying the image delivered from the moving image distribution server 500 or the information acquired from the SNS server 600 based on a control signal from the control unit 310.

As the information terminal 300, typically, a mobile phone (including smartphone) or a desktop or notebook personal computer (PC) can be used. Moreover, the information terminal 300 may be configured by using in-vehicle equipment such as a navigation device mounted on a vehicle. The information terminal 300 corresponds to an “information terminal” of the present invention, and the display unit 320 of the information terminal 300 corresponds to an “output unit” of the present invention.

Though not shown, the information terminal 300 includes an input device. The input device includes, for example, in the case of the smartphone, a touch panel of the display unit 320. For example, in the case of a mobile phone other than the smartphone, the input device includes input keys mounted by being arranged adjacent to the display unit 320. For example, in the case of the personal computer, the input device includes a mouse or a touch pad as a pointing device.

The moving image distribution server 500 includes a control unit 510 including a CPU and other components as in the case of the control unit 310. The control unit 510 functions to temporarily store moving images or information regarding the moving images periodically or continuously captured by photographing device 100 and transmitted via the network 400. The moving images stored in the moving image distribution server 500 can be provided to the user in a moving image distribution site managed by the moving image distribution server 500. For example, in a state of accessing the moving image distribution site, a moving image search operation or a moving image reproduction operation is performed on the information terminal 300 side. In this manner, a predetermined moving image is delivered to the information terminal 300 via the network 410 to be displayed on the display unit 320. Alternatively, the user of the information terminal 300 downloads a predetermined moving image from the moving image distribution server 500 via the network 410 and, in this manner, this moving image is displayed on the display unit 320.

The SNS server 600 includes a control unit 610 including a CPU and other components as in the case of the control unit 310. The control unit 610 functions to store information (e.g., subscriber name, telephone number of information terminal 300, e-mail address, ID information for identifying user, or account information used by user to participate in network services) regarding the user (subscriber or user) of the information terminal 300. Moreover, the control unit 610 functions to store registration information registered in the SNS from each information terminal 300, and read, in response to a browsing request from the user of the information terminal 300, namely, in accordance with a control signal from the control unit 310, information relating to the browsing from pieces of stored information to output the information to the display unit 320 of the information terminal 300. The SNS server 600 is temporarily or continuously connected to the moving image distribution server 500 via the network 430 similar to the network 400 so as to be able to communicate information to/from the moving image distribution server 500. For example, the moving image stored in the moving image distribution server 500 is output to the display unit 320 of the information terminal 300 via the SNS server 600.

Information providing processing for providing information regarding the moving image of the predetermined object 110 to the information terminal 300 is specifically described. This information providing processing is generally processing for registering the information regarding the moving image requested by the user of the information terminal 300 and giving a notification to the user based on the registration, and includes “registration processing” and “remind processing” described below. In this case, the moving image distribution server 500 and the SNS server 600 constitute an information management server for managing a site that is registered by the user and is capable of providing information on the network, and the information management server is also connected to the information terminal 300 via the networks 410 and 420 so as to be able to communicate information to/from the information terminal 300. This information providing processing can be carried out mainly under control of at least one control unit selected from the control units 310, 510, and 610 of the information terminal 300, the moving image distribution server 500, and the SNS server 600. In this case, the device including this control unit constitutes an “information-providing device” of the present invention.

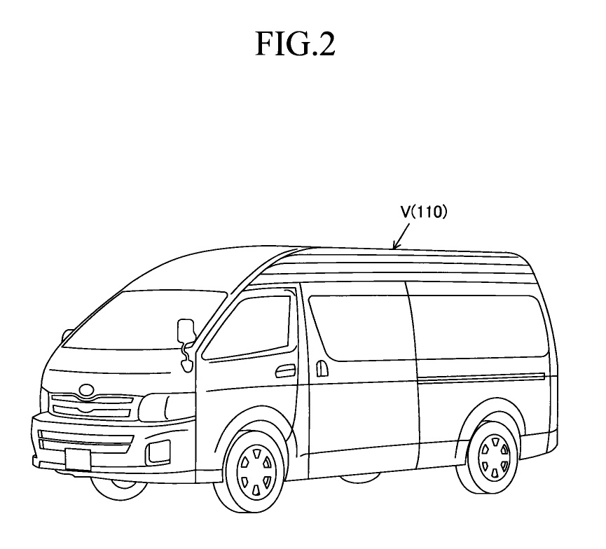

For the predetermined object 110, reference is made to FIG. 2. A vehicle V illustrated in FIG. 2 is an example of the predetermined object 110. The vehicle V is capable of traveling on a road surface, and configured as a bus enabling boarding or alighting at a reserved place and time, namely, “on-demand bus”. Company's advertising information or the like can be added to an outer surface of the vehicle V when necessary.

(Registration Processing)

The registration processing is processing for registering a predetermined moving image by the user of the information terminal 300 before the recommendation processing (hereinafter also referred to as “remind registration”). After execution of the registration processing, the user of the information terminal 300 can be reminded of pre-registration of the moving image at subsequent appropriate timing. A case where a moving image A of the vehicle V as the predetermined object 110 is registered by the user of the information terminal 300 is described. Moving images other than the moving image A can be similarly registered through this registration processing.

Referring to a flowchart of the registration processing illustrated in

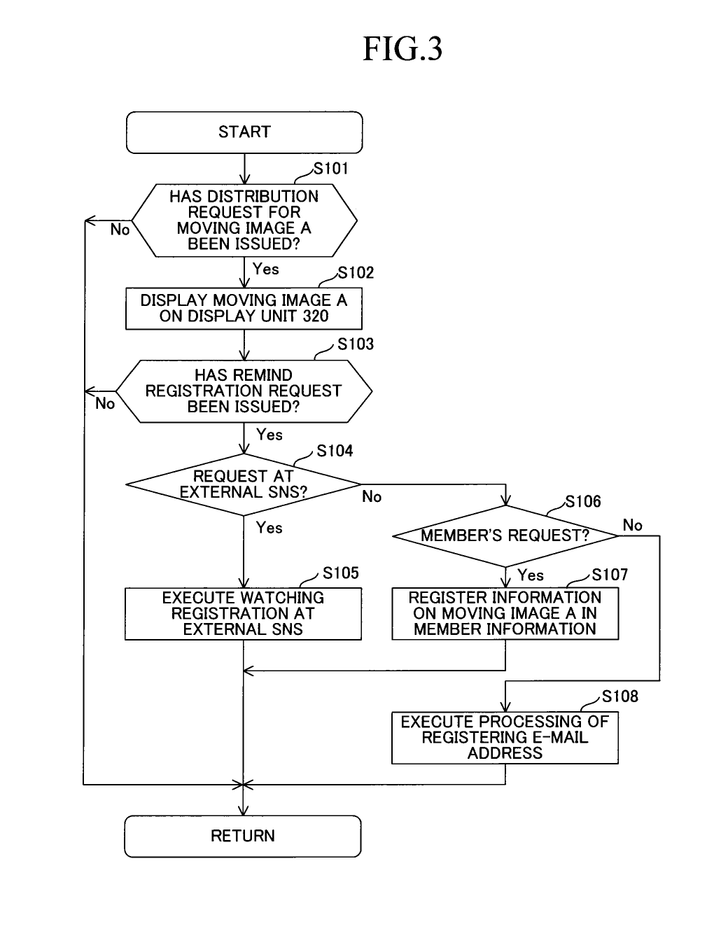

FIG. 3, first, in Step S101, whether a distribution request for the moving image A has been issued to a predetermined moving image distribution site is determined. When the condition of Step S101 is satisfied (Yes in Step S101), namely, when it is determined that the distribution request for the moving image A has been issued, the processing proceeds to Step S102. For example, by determining that the user of the information terminal 300 has operated the above-mentioned input device to input the distribution request, it is determined that the distribution request for the moving image A has been issued. On the other hand, when the condition of Step S101 is not satisfied (No in Step S101), namely, when it is determined that no distribution request for the moving image A has been issued, the registration processing is ended.

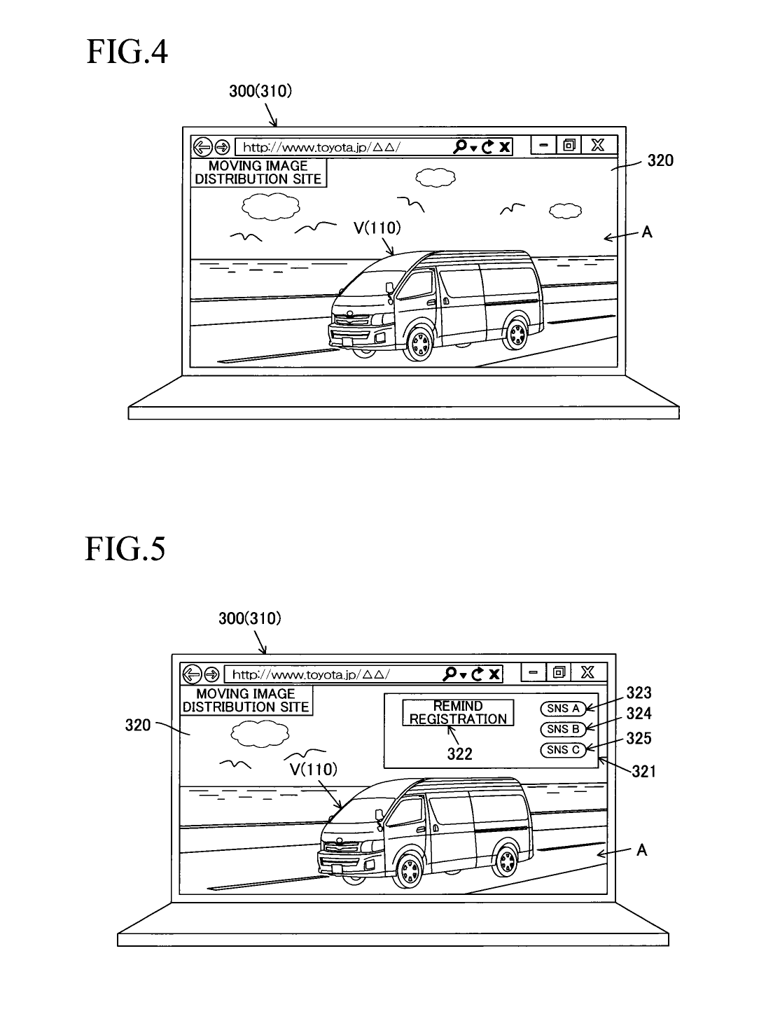

In Step S102, the moving image A the distribution of which has been requested to the moving image distribution site is displayed on the display unit 320. In this case, the control unit accesses the moving image distribution site managed by the moving image distribution server 500 via the network 410 to read information regarding the moving image A from the moving image distribution server 500. Accordingly, for example, as illustrated in FIG. 4, the moving image A of the traveling vehicle V is displayed on the display unit 320 of the information terminal 300.

In Step S103, whether a remind registration request for the moving image A has been issued is determined. When the condition of Step S103 is satisfied (Yes in Step S103), namely, when it is determined that a remind registration request has been issued, the processing proceeds to Step S104. Through this remind registration, the user can be notified of pre-registration of the moving image A at subsequent appropriate timing. On the other hand, when the condition of Step S103 is not satisfied (No in Step S103), namely, when it is determined that no remind registration request has been issued, the registration processing is ended.

In Step S104, whether a remind registration request is to be issued at an external SNS is determined. When the condition of Step S104 is satisfied (Yes in Step S104), namely, when it is determined that a remind registration request is to be issued at the external SNS, the processing proceeds to Step S105. On the other hand, when the condition of Step S104 is not satisfied (No in Step S104), namely, when it is determined that no remind registration request is to be issued at the external SNS, the processing proceeds to Step S106.

In Step S105, processing (watching processing) for monitoring information (e.g., update information on moving image A, registration information on moving image A, or the like) regarding the moving image A at the external SNS is performed. An appropriate notification is issued at the SNS based on this processing. Specifically, updating of the moving image A is displayed on a display section for notifying recent statuses on the SNS, what is called “news feed”, for example, after the moving image has been updated. The registration processing is ended after the execution of Step S105.

In Step S106, whether a remind registration request has been made by a member of the moving image distribution site is determined. When the condition of Step S106 is satisfied (Yes in Step S106), in other words, when it is determined that a remind registration request has been made by the member of the moving image distribution site, the processing proceeds to Step S107. On the other hand, when the condition of Step S106 is not satisfied (No in Step S106), in other words, when it is determined that a remind registration request has not been made by the member of the moving image distribution site, the processing proceeds to Step S108.

Each of the above-mentioned determination processes of Steps S103 to S105 is described referring to FIGS. 5 to 7.

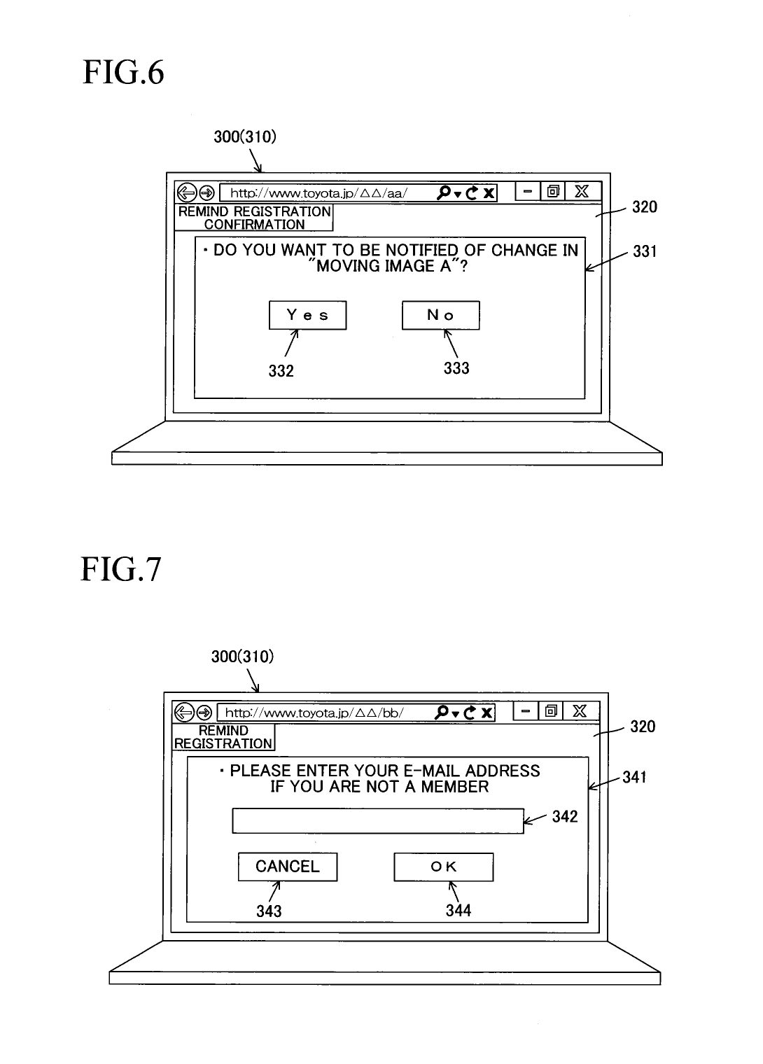

As illustrated in FIG. 5, in relation to S103, it is preferred that display information 321 for verifying the user's intension to request a remind registration be displayed with the moving image A on the display unit 320. The display information 321 includes a selection key 322 of “remind registration”. By selecting the selection key 322 on a screen, for example, display information 331 for confirming remind registration is subsequently displayed on the display unit 320 as illustrated in FIG. 6. As illustrated in FIG. 6, the display information 331 includes a display of “DO YOU WANT TO BE NOTIFIED OF A CHANGE IN ‘MOVING IMAGE A’?”, a selection key 322 of “Yes”, and a selection key 333 of “No”. In this case, in Step S103, by the selection key 332 being selected on the screen, it is determined that a remind registration request has been received. On the other hand, in Step S103, by the selection key 333 being selected on the screen, it is determined that no remind registration request has been received.

In relation to Step S104, the above-mentioned display information 321 includes a selection key 323 of “SNS A”, a selection key 324 of “SNS B”, and a selection key 325 of “SNS C”. A user wishing to request remind registration by using the external SNS can select one or a plurality of corresponding SNSs that the user has registered in advance on the screen. Through selection of the selection keys 323 to 325 on the screen, information indicating that the user of the information terminal 300 recommends or affirms the moving image A, for example, information “like”, is registered in the SNS server 600.

By the selection keys 323 to 325 being selected on the screen, it is determined that a remind registration request is to be issued at the external SNS. For example, after the selection key 323 has been selected on the screen, a remind registration request is to be issued at the “SNS A”. In place of or in addition to the selection keys 323 to 325, a selectable selection key can be set when there is a wish to issue remind registration requests en bloc to all the SNSs. On the other hand, after the selection key 322 or the selection key 333 has been selected, in Step S104, it is determined that no remind registration request is issued at the external SNS.

In relation to Step S106, it is preferred that, by the selection key 332 of the display information 331 being selected on the screen, display information 341 for inputting, for example, an e-mail address of a person other than the member of the moving image distribution site be subsequently displayed as illustrated in FIG. 7. As illustrated in FIG. 7, the display information 341 includes a display of “PLEASE ENTER YOUR E-MAIL ADDRESS IF YOU ARE NOT A MEMBER”, an input region 342 to which the e-mail address can be input, a selection key 343 of “cancel”, and a selection key 344 of “OK”. In this case, by the selection key 344 being selected after the address has been input to the input region 342, in Step S106, it is determined that a remind registration request has not been issued from the member of the moving image distribution site. In Step S108, the input address is directly registered. The input region 342 may be configured to allow an account input in place of the e-mail address. On the other hand, by the selection key 343 being selected on the screen, the address inputting is canceled, or the registration of the address input to the input region 342 is canceled. The registration processing is ended after the execution of Step S108.

After the selection key 322 of the above-mentioned display information 321 has been selected, in Step S106, it is determined that a remind registration request has been issued by the member of the moving image distribution site. In this case, in Step S107, information on the moving image A as the remind object is registered in member information of the user. For example, the moving image A is registered in favorite information of the moving image distribution site in which the user of the information terminal 300 is a member. The registration processing is ended after the execution of Step S107.

(Recommendation Processing)

Recommendation processing can be performed on the premise that the above-mentioned registration processing has been completed. Through this recommendation processing, remind registration of a predetermined moving image can be notified to the user of the information terminal 300 at subsequent appropriate timing.

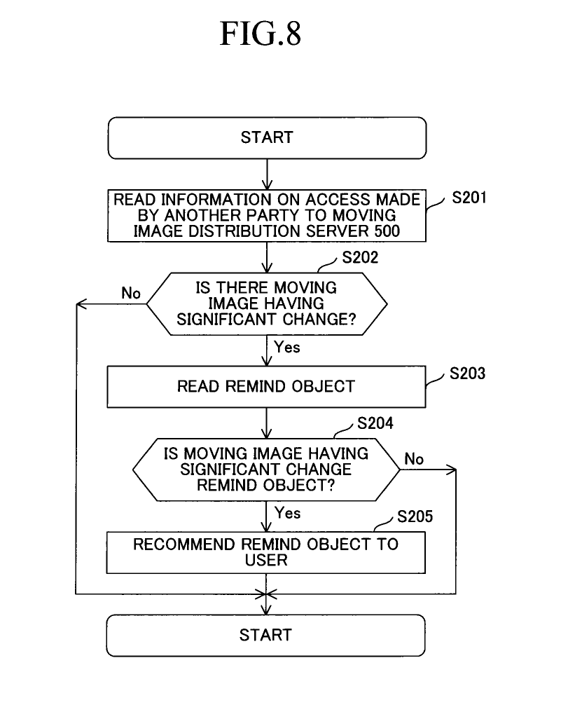

In a flowchart of the recommendation processing illustrated in FIG. 8, first, in Step S201, information on access made by another party to the moving image distribution server 500 is read. For example, access is made to the moving image distribution server 500 to read and acquire the information on accesses (e.g., number of accesses to moving image (number of browsing times) or number of times of delivering moving images) made by another party with respect to one or a plurality of moving images therefrom. In this case, moving images targeted by the access information may be all the moving images registered in the moving image distribution server 500, or one or a plurality of moving images selected from all the moving images registered in the moving image distribution server 500. For example, if only the moving image A illustrated in FIG. 4 is focused on, only information on accesses made by another party to the moving image A is acquired.

The “another party” as used herein is typically defined as a user different from the predetermined user who has carried out the above-mentioned registration processing. For example, another party includes people having a particular relationship with the predetermined user such as friends or those belonging to the same community, or people having no particular relationship with the user. The another party may be the same person, or a plurality of people. As the “same community” as used herein, typically, a community on a network where schools, regions, or hobbies are identical or similar can be given.

In Step S202, by using the information on accesses made by another party acquired in Step S201, it is determined whether the moving images of the moving image distribution server 500 include any moving image having a significant change. Accordingly, the control unit configured to execute the recommendation processing can be referred to as determination means for determining whether the moving images of the moving image distribution server 500 include any moving image having a significant change. When the condition of Step S202 is satisfied (Yes in Step S202), namely, when there is a moving image having a significant change, the processing proceeds to Step S203. On the other hand, when the condition of Step S202 is not satisfied (No in Step S202), namely, when there is no moving image having a significant change, the recommendation processing is ended. In this case, not an error or an accident but clearly a meaningful or substantiated change can be regarded as a “significant change”. Accordingly, by using a criterion (criterion enabling removal of error or accident) set in advance, it is preferred to determine whether a current event is a significant change.

In Step S203, the remind object that has been subjected to the remind registration in the above-mentioned registration processing, for example, the moving image A, is read.

In Step S204, by comparing the moving image of the significant change specified in Step S202 with the remind object read in Step S203, whether the moving image of the significant change is a remind object is determined. Accordingly, the control unit configured to execute the recommendation processing can be referred to as determination means for determining whether the moving image of the significant change is a remind object. When the condition of Step S204 is satisfied (Yes in Step S204), namely, when the moving image of the significant change is a remind object, the processing proceeds to Step S205. For example, the moving image A is set as a remind object. On the other hand, when the condition of Step S204 is not satisfied (No in Step S204), namely, the moving image of the significant change is not a remind object, the recommendation processing is ended.

In Step S205, to recommend the moving image A that is a remind object to the user of the information terminal 300, recommendation information regarding the moving image A is displayed on the display unit 320 of the information terminal 300. Accordingly, the user can recognize that a significant change has been made to the moving image registered by the user itself in the past.

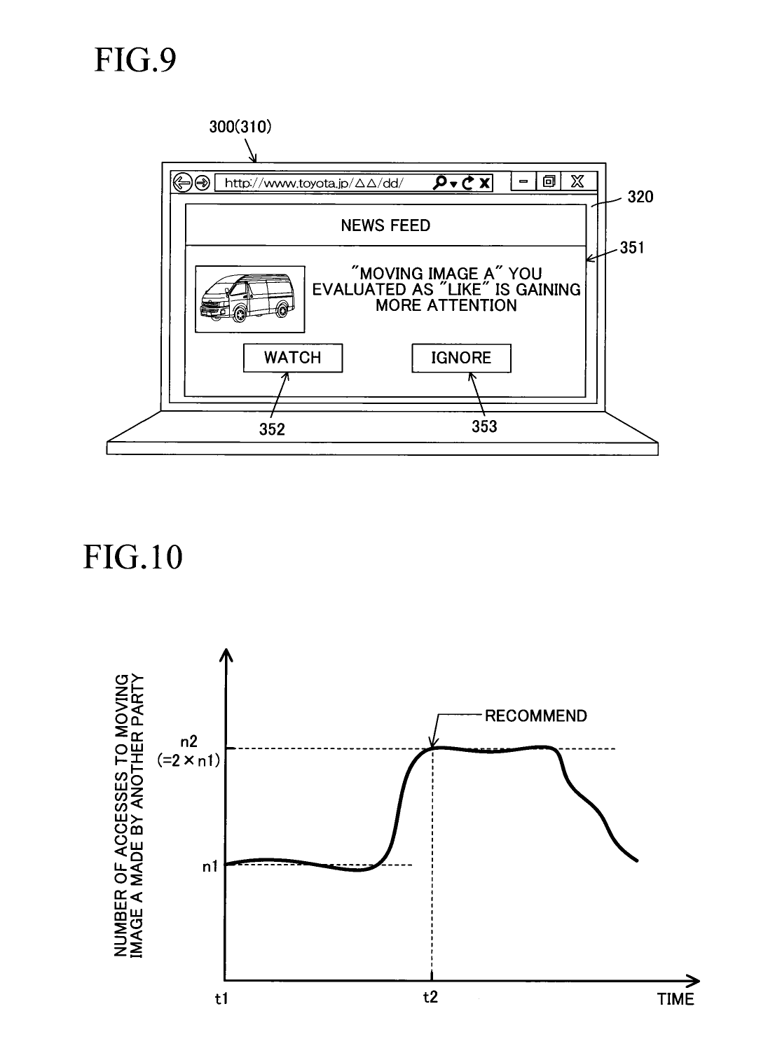

The recommendation processing illustrated in FIG. 8 has been directed to the case where the moving image of the significant change is set as the remind object. However, the present invention can employ an embodiment where a remind object is set by using the access status (number of accesses, frequency of accesses, access hour (time zone), times of accesses, or the like) made by another party to the moving image. This embodiment is described referring to FIGS. 9 to 11.

The embodiment illustrated in FIG. 9 is premised on a case where, for example, in Step S105 of FIG. 3, the moving image A is subjected to the watching registration at the external SNS. In this case, corresponding to Step S205 described above, display information 351 is displayed on the display unit 320 of the information terminal 300. The display information 351 is for notifying access status of another party to the moving image A, and includes recommendation information “‘MOVING IMAGE A’ YOU EVALUATED AS ‘LIKE’ IS GAINING MORE ATTENTION”. For example, when the number of times of registering information “like” by another party regarding the moving image A reaches a threshold value, namely, when the number of accesses to the SNS reaches a threshold value, it is determined that the moving image A is gaining more attention. Accordingly, the user can recognize that a significant change has been made to the moving image A registered by user itself. In this case, as long as the user logs in the SNS, the user can acquire recommendation information regarding the moving image A by another information terminal without being limited to any specific information terminal. The number of accesses may be a total value of the number of accesses made by another party, namely, an absolute number, or the number of accesses per unit time, namely, a change rate.

Moreover, the display information 351 includes a selection key 352 of “watch” and a selection key 353 of “ignore”. When the selection key 352 is selected, the moving image A is displayed on the display unit 320 of the information terminal 300. In this case, the moving image A displayed on the display unit 320 may be a moving image updated in real time, a moving image recorded in advance, or an update amount of the moving image recorded in advance. On the other hand, when the selection key 353 is selected, the moving image A is not displayed on the display unit 320 of the information terminal 300.

Timing of the recommendation in the embodiment illustrated in FIG. 9 is described referring to FIG. 10. As shown in FIG. 10, supposing that the number of accesses to the moving image A of the moving image distribution site at normal time t1 is n1, for example, when the number of accesses reaches n2 (=2×n1) that is double that at the normal time, another party clearly is paying more attention to the moving image A, and thus it can be determined that a significant change has been made to in the moving image A. In such a case, with the number of accesses n2 set as a threshold value, recommendation information regarding the moving image A can be recommended at time t2 corresponding to the number of accesses n2. In this case, a ratio of n2 to n1 is not limited to 2. A ratio exceeding 1 can be appropriately selected as occasion demands.

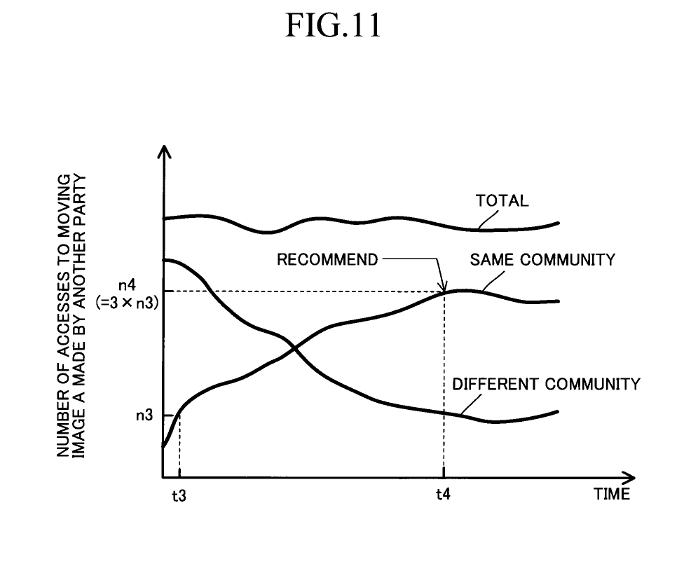

As a modified example of FIG. 10, as shown in FIG. 11, the number of accesses made by another party to the moving image A of the moving image distribution site belonging to the same community can be used. In this case, the number of accesses by another party not belonging to the same community (another party of different community) has decreased with a passage of time, and the number of accesses among all other parties is approximately constant. On the other hand, for another party belonging to the same community, the number of accesses has increased threefold from about n3 to n4 from time t3 to t4, clearly showing that specific another party is paying more attention to the moving image A. In such a case, with the number of accesses n4 set as a threshold value, recommendation information regarding the moving image A can be recommended at the time t4 corresponding to the number of accesses n4. In this case, a ratio of n4 to n3 is not limited to 3. A ratio exceeding 1 can be appropriately selected as occasion demands.

In place of the aspects where the recommendation information is recommended when the number of accesses made by another party reaches the threshold value illustrated in FIGS. 10 and 11, when the frequency of accesses by another party within a certain period reaches a threshold value, or when the access time (time zone) or an access hour made by another party is uneven, recommendation information may be recommended.

According to the information-providing system 10, the user can confirm, after recognition of the recommendation information regarding the moving image distribution site registered in advance, the significant change of the moving image distribution site status by accessing the moving image distribution site when necessary. Thus, without giving any burdensome feeling to the user, information necessary for the user, for example, a great change of the access status of another party (including another party belonging to the same community) to the moving image A of the moving image distribution site can be notified. In particular, by reflecting a tendency of another party having a nature and a sense of value similar to those of the user as in the case of another party belonging to the same community, important information having particularly high relevance to the user can be accurately provided.

When there is a significant change made to a state of various types of information (e.g., contents, images (moving image, still image), movies, music, theaters, literatures, photographs, cartoons, animations, computer games, and other characters, graphics, colors, sounds, or movements, or combination of these) in the site and opened to the public in the site, recommendation information may be recommended. In this case, for example, when the information in the site is updated (changed, added, or the like), it can be determined that a significant change has been made. Thus, without giving any burdensome feeling to the user, the updating of the information in the site can be reliably notified to the user.

When the information in the site as described above is a fixed point image registered in the moving image distribution site, it can be determined that a significant change has been made to the information status in the site when the fixed point image is updated. Accordingly, without giving any burdensome feeling to the user, the updating of the fixed point image, which is information in the site, can be reliably notified to the user. In particular, concerning information such as the fixed point image where a change is small, chances for actively accessing the site for managing the information by the user are predicted to be reduced with a passage of time or an increase of the number of registered sites. However, the information-providing device according to the embodiment is effective as means for preventing the user from missing necessary information.

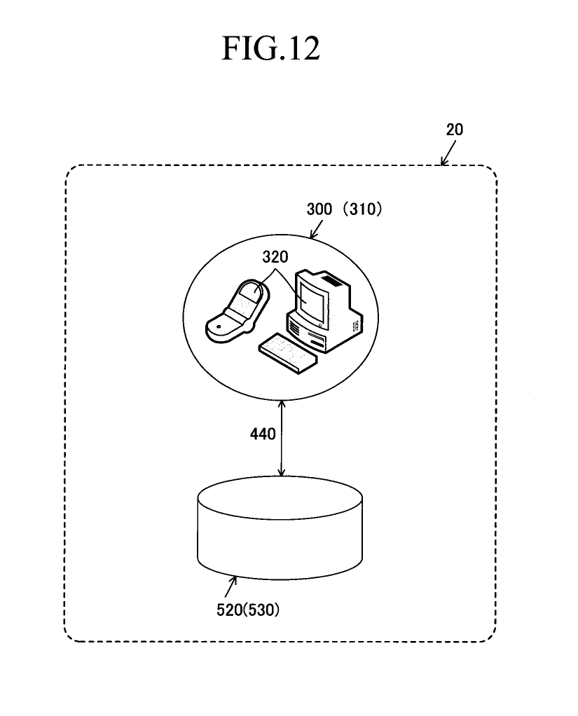

The embodiment described above has been directed to the case where the information providing processing is performed by using the information-providing system 10 illustrated in FIG. 1. However, according to the present invention, another type of an information-providing system different from the information-providing system 10 can be employed. The information-providing system of another type is described referring to FIGS. 12 to 15.

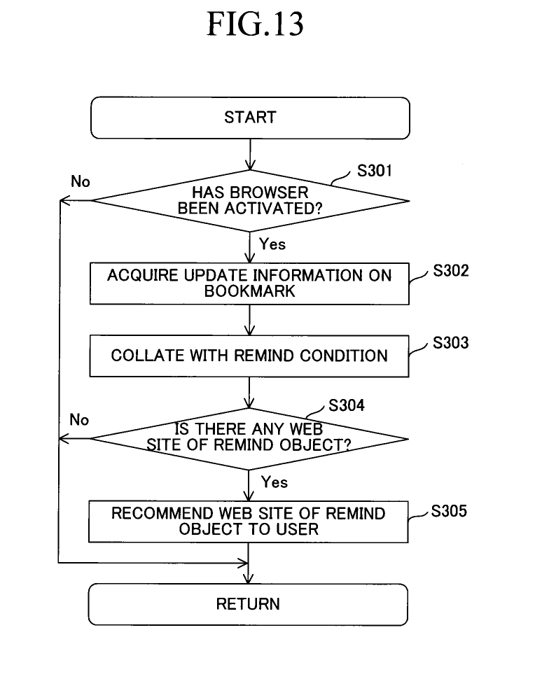

An information-providing system 20 illustrated in FIG. 12 is a modified example of the information-providing system 10 illustrated in FIG. 1, and includes, as components, an information terminal 300, a local server 520, and a local area network 440 for interconnecting the information terminal 300 and the local server 520 to be able to communicate information. The local server 520 includes a control unit 530 including a CPU and other components as in the case of the control unit 310. According to this information-providing system 20, in place of the recommendation processing illustrated in FIG. 8, recommendation processing illustrated in FIG. 13 can be employed. In this case, the recommendation processing can be performed mainly under control of the control unit 310 of the information terminal 300. Thus, in the information-providing system 20, the information terminal 300 corresponds to the “information-providing system” of the present invention.

In a flowchart of recommendation processing illustrated in FIG. 13, first, in Step S301, the control unit 310 determines whether a browser has been activated. When the condition of Step S301 is satisfied (Yes in Step S301), namely, when the browser has been activated, the processing proceeds to Step S302. On the other hand, when the condition of Step S301 is not satisfied (No in Step S301), namely, when the browser has not been activated, the recommendation processing is ended.

In Step S302, after Step S301, the control unit 310 acquires update information on a preset bookmark (or “favorite”). In this case, the “bookmark” is used to store the address (uniform resource locator (URL)) as address on the Internet or the like) of a web site where moving images and various type of information other than the moving images can be browsed. Accordingly, the user can recognize whether the web site corresponding to the bookmark has been updated.

In Step S303, after Step S302, the control unit 310 collates data with a remind condition. In this case, as the “remind condition”, for example, a condition that another party is clearly paying more attention to a predetermined moving image and thus a significant change has been made to the moving image can be given.

In Step S304, the control unit 310 determines whether there is any web site matching the remind condition of Step S303. When the condition of Step S304 is satisfied (Yes in Step S304), namely, when there is a web site matching the remind condition, the processing proceeds to Step S305. For example, when there is a significant change made to the moving image A, the moving image A is a remind object matching the remind condition and the web site enabling browsing of the moving image A matches the condition of Step S304. On the other hand, when the condition of Step S304 is not satisfied (No in Step S304), namely, when there is no web site matching the remind condition, the recommendation processing is ended.

In Step S305, the control unit 310 recommends the web site of the remind object specified in Step S304 to the user of the information terminal 300. Accordingly, the user can recognize that a significant change has been made to the moving image bookmarked by the user itself.

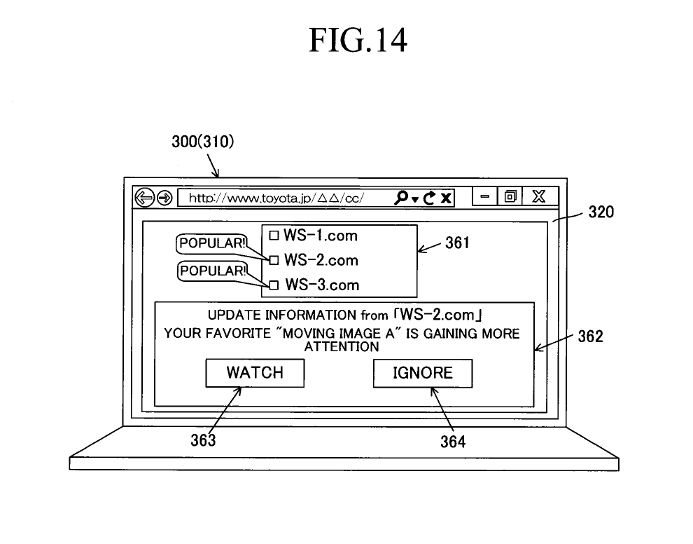

Specific example of Steps S302 to S305 are described referring to FIG. 14.

After the acquisition of the update information of the bookmark in Step S302, as illustrated in FIG. 14, the update information is reflected in a bookmark region 361 displayed on the display unit 320 of the information terminal 300. For example, an update display (e.g., “popular (reputation)!”) indicating that a significant change has been made to the web site is added around the display of “WS-2.com” or WS-3.com” indicating a site name of the web site bookmarked in advance.

As a modified example of this aspect, according to the acquisition of the update information of the bookmark, a display position of the site name in the bookmark region 361 can be changed. In this case, the site name of the relevant web site can be displayed, in a state where the above-mentioned update display is added, or without adding the above-mentioned update display, at a position more conspicuous than site names of other web sites. For example, when a significant change has been made, among three web sites respectively displayed at three rows of the bookmark region 361, to the web site of the second row, display places of site names of the three web sites can be replaced so that a site name of the web site of the second row is displayed at the first row. As another modified example, in response to the acquisition of the update information of the bookmark, a display form (e.g., size, character style, color, or the like) of the site name of the relevant web site can be changed.

After Steps S303 and S304, when the web site of the remind object is recommended to the user of the information terminal 300 in Step S305, for example, as illustrated in FIG. 14, display information 362 for this recommendation is displayed on the display unit 320 of the information terminal 300. This display information 362 is for notifying access status of another party to the moving image A, and includes recommendation information of “YOUR FAVORITE ‘MOVING IMAGE A’ IS GAINING MORE ATTENTION” for “WS-2.com”. For example, when the status of accesses made by another party to the moving image A (e.g., number of accesses) reaches a threshold value, or when the number of times of registration of information another party evaluated as “like” reaches a threshold value, it is determined that the moving image A is gaining more attention. Accordingly, the user can recognize that a significant change has been made to the moving image A registered by the user itself.

Moreover, the display information 362 includes a selection key 363 of “watch” and a selection key 364 of “ignore”. When the selection key 363 is selected, the control unit 310 accesses “WS-2.com” to output the moving image A to the display unit 320. In this case, the moving image A displayed on the display unit 320 may be a moving image updated in real time, a moving image recorded in advance, or an update amount of the moving image recorded in advance. On the other hand, when the selection key 364 is selected, the updated moving image A is not displayed on the display unit 320.

According to the information-providing system 20, as in the case of the above-mentioned information-providing system 10, without giving any burdensome feeling to the user, information necessary for the user can be reliably notified. By acquiring access status of another party (e.g., number of accesses) to the moving image A from the web site, processing can be completed in the browser. In this case, outputting of information to the outside of the local server 510 can be blocked. The number of times of registration of information another party evaluated as “like” is displayed on the web site. Accordingly, the user can roughly recognize whether any significant change has been made to the moving image A without logging into any web site or SNS. Needless to say, the user can acquire detailed information as to whether any significant change has been made to the moving image A by logging into a web site or a SNS when necessary.

According to the above-mentioned information-providing systems 10 and 20, when the user accesses the site (e.g., by selecting selection key 352 illustrated in FIG. 9 or selection key 363 illustrated in FIG. 14) in response to the recommendation information displayed on the display unit 320 of the information terminal 300, based on a browsing mode of the user in this site, a criterion for determining that a significant change has been made to the site status can be changed. Accordingly, the above-mentioned control unit performing the recommendation processing can be referred to as changing means for changing the criterion for determining that the significant change has been made to the site state. As the “user's browsing mode” as used herein, typically, time or an hour when the user browsed the site and the number of actions made by the user in the site (e.g., number of times of browsing web pages (number of pages), or number of clicks on web page) can be given.

In this case, when the user seems to show an insufficient interest in information in the site even if the user has accessed the site in response to the recommendation information (e.g., user closes site immediately after accessing the site (within short time), setting can be changed so that a criterion is stricter, namely, outputting of the recommendation information is difficult. For example, the number of accesses n2 where the recommendation is executed in FIG. 10 can be changed to a value larger than a double of n1. The number of accesses n4 where the recommendation is executed in FIG. 11 can be changed to a value larger than a triple of n3. As a result, information to be notified to the user can be selected more carefully. After the criterion has been changed, the changing can be notified to the user by using, for example, the display unit 320 of the information terminal 300 or the like. Thus, the user can easily recognize that the criterion has been changed.

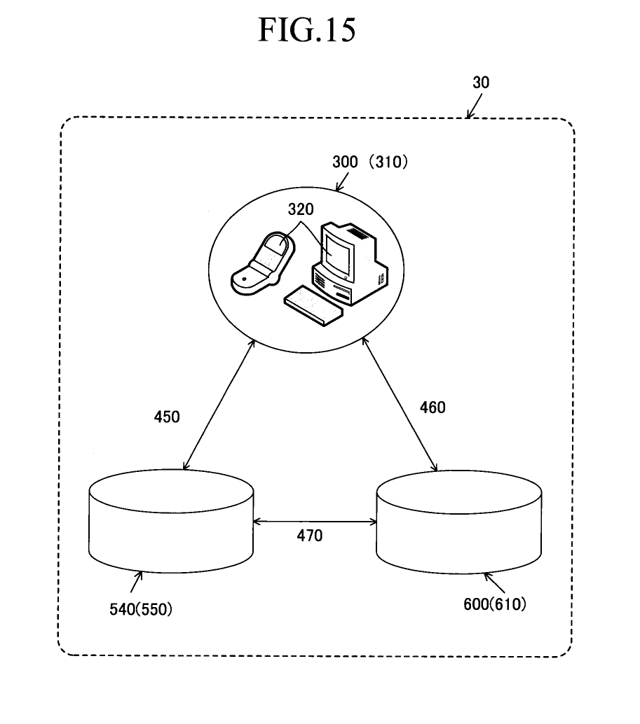

An information-providing system 30 illustrated in FIG. 15 is a modified example of the information-providing system 10 illustrated in FIG. 1, and includes, as components, an information terminal 300, an information providing server 540, an SNS server 600, and networks 450, 460, 470 for interconnecting those three elements to be able to communicate information. In this configuration, the information providing server 540 includes a control unit 550 including a CPU and other components as in the case of a control unit 310. The information providing server 540 and the SNS server 600 constitute an information management server for managing a site that is registered by a user and is capable of providing information on a network, and the information management server is also connected to the information terminal 300 via the networks 450 and 460 so as to be able to communicate information. According to this information-providing system 30, by using the information providing server 540 in place of the moving image distribution server 500 of the information-providing system 10, not only images such as moving and still images but also information other than the images can be provided to the user. According to the information-providing system 30, without giving any burdensome feeling to the user, necessary information can be reliably notified to the user. When necessary, the SNS server 600 and the networks 460 and 470 associated therewith can be omitted.

The above-mentioned embodiment has been directed to the case where the recommendation information for recommending access to the site is displayed on the display unit 320 of the information terminal 300. According to the present invention, however, the recommendation information can be output by using a display device other than the display unit 320 or an audio output device such as a speaker.

The above-mentioned embodiment has been directed to the case where the moving image is delivered to the information terminal 300. However, the present invention can be applied to a technology for delivering at least one of a moving image and a still image, or information other than the image to the information terminal 300. When the moving image is delivered, the moving image may be a fixed point image acquired by capturing an image at a fixed point or an unfixed point image acquired by capturing an image at an unfixed point.

Based on the above-mentioned embodiments and various modified examples, the present invention can employ the following aspects.

In the present invention, the following aspect (Aspect 1) can be employed.

An information-providing method for providing information to a user, including notifying, when there is a significant change has been made, through involvement of another party other than the user, to a site status of a predetermined site registered by the user and capable of providing information on a network, the user of recommendation information for recommending access to the predetermined site.

In the present invention, the following aspect (Aspect 2) can be employed.

An information-providing method according to Aspect 1, in which the site status is a status of information in the predetermined site, the information in the predetermined site being registered by the another party in the predetermined site and opened to public in the predetermined site.

In the present invention, the following aspect (Aspect 3) can be employed.

An information-providing method, in which:

the information in the predetermined site is a fixed point image, which is an image of a preset fixed point registered in the predetermined site by the another party; and

the information-providing method further includes determining that a significant change has been made to the status of the information in the predetermined site when the fixed point image is updated.

In the present invention, the following aspect (Aspect 4) can be employed.

An information-providing method according to Aspect 1, in which the site status is an access status by the another party to the site.

In the present invention, the following aspect (Aspect 5) can be employed.

An information-providing method according to Aspect 4, in which:

the access status is a number of accesses to the predetermined site by a person who is the another party in one or a plurality of social networking services and belongs to the same community as a community of the user; and the information-providing method further includes determining that a significant change has been made to the access status when the number of accessing times reaches a preset threshold value.

In the present invention, the following aspect (Aspect 6) can be employed.

An information-providing method according to any one of Aspects 1 to 5, further including changing, when the user accesses the predetermined site in response to the recommendation information output from the output unit, a criterion for determining that a significant change has been made to the site status, based on a browsing mode of the user in the predetermined site.

1. An information-providing device for providing information to a user, comprising:
an output unit capable of outputting information; and
a control unit for causing, when a significant change has been made, through involvement of another party other than the user, to a site status of a predetermined site registered by the user and capable of providing information on a network, the output unit to output recommendation information for recommending access to the predetermined site.

2. An information-providing device according to claim 1, wherein the site status comprises a status of information in the predetermined site, the information in the predetermined site being registered by the another party in the predetermined site and opened to public in the predetermined site.

3. An information-providing device according to claim 2, wherein:
the information in the predetermined site comprises a fixed point image, which is an image of a preset fixed point registered in the predetermined site by the another party; and
the control unit determines that a significant change has been made to the status of the information in the predetermined site when the fixed point image is updated.

4. An information-providing device according to claim 1, wherein the site status comprises an access status of another party to the site.

5. An information-providing device according to claim 4, wherein:
the access status comprises a number of accesses to the predetermined site by a person who is the another party in one or a plurality of social networking services and belongs to the same community as a community of the user; and
the control unit determines that a significant change has been made to the access status when the number of accessing times reaches a preset threshold value.

6. An information-providing device according to claim 1, wherein the control unit changes, when the user accesses the predetermined site in response to the recommendation information output from the output unit, a criterion for determining that a significant change has been made to the site status, based on a browsing mode of the user in the predetermined site.

7. An information-providing system for providing information to a user, comprising:
an information terminal comprising an output unit capable of outputting information; and
an information management server for managing a predetermined site, which is registered by the user and is capable of providing information on a network, the information management server being connected to the information terminal via the network to be able to communicate information to and from the information terminal,
wherein the information terminal or the information management server includes a control unit for causing, when a significant change has been made, through involvement of another party other than the user, to a site status of the predetermined site, the output unit of the information terminal to output recommendation information for recommending access to the predetermined site.

8. An information-providing system according to claim 7, wherein the site status comprises a status of information in the predetermined site, the information in the predetermined site being registered by the another party in the predetermined site and opened to public in the predetermined site.

9. An information-providing system according to claim 8, further comprising a photographing device capable of capturing an image at a preset fixed point and transmitting information on the image to the information management server via the network, wherein:
the information in the predetermined site comprises a fixed point image, which is the image of the preset fixed point captured by the photographing device and registered in the predetermined site by the another party; and
the control unit determines that a significant change has been made to the status of the information in the predetermined site when the fixed point image is updated.

10. An information-providing system according to claim 7, wherein the site status comprises an access status of the another party to the site.

11. An information-providing system according to claim 10, wherein:
the access status comprises a number of accesses to the site by a person who is the another party in one or a plurality of social networking services (SNSs) and belongs to the same community as a community of the user; and
the control unit determines that a significant change has been made to the access status when the number of accessing times reaches a preset threshold value.

12. An information-providing system according to claim 7, wherein the control unit changes, when the user accesses the site in response to the recommendation information output from the output unit, a criterion for determining that a significant change has been made to the site status, based on a browsing mode of the user in the site.

13. An information-providing device according to claim 2, wherein the control unit changes, when the user accesses the predetermined site in response to the recommendation information output from the output unit, a criterion for determining that a significant change has been made to the site status, based on a browsing mode of the user in the predetermined site.

14. An information-providing device according to claim 3, wherein the control unit changes, when the user accesses the predetermined site in response to the recommendation information output from the output unit, a criterion for determining that a significant change has been made to the site status, based on a browsing mode of the user in the predetermined site.

15. An information-providing device according to claim 4, wherein the control unit changes, when the user accesses the predetermined site in response to the recommendation information output from the output unit, a criterion for determining that a significant change has been made to the site status, based on a browsing mode of the user in the predetermined site.

16. An information-providing device according to claim 5, wherein the control unit changes, when the user accesses the predetermined site in response to the recommendation information output from the output unit, a criterion for determining that a significant change has been made to the site status, based on a browsing mode of the user in the predetermined site.

17. An information-providing system according to claim 8, wherein the control unit changes, when the user accesses the site in response to the recommendation information output from the output unit, a criterion for determining that a significant change has been made to the site status, based on a browsing mode of the user in the site.

18. An information-providing system according to claim 9, wherein the control unit changes, when the user accesses the site in response to the recommendation information output from the output unit, a criterion for determining that a significant change has been made to the site status, based on a browsing mode of the user in the site.

19. An information-providing system according to claim 10, wherein the control unit changes, when the user accesses the site in response to the recommendation information output from the output unit, a criterion for determining that a significant change has been made to the site status, based on a browsing mode of the user in the site.

20. An information-providing system according to claim 11, wherein the control unit changes, when the user accesses the site in response to the recommendation information output from the output unit, a criterion for determining that a significant change has been made to the site status, based on a browsing mode of the user in the site.
